(19) United States
(12) Patent Application Publication
(10) Pub. No.: US 2017/0183160 A1
(43) Pub. Date: Jun. 29, 2017

(54) METHOD FOR CONTROLLING THE PRESSURE IN AN UNDERGROUND STORAGE VOLUME

(71) Applicant: Air Liquide Oil and Gas Services Limited, West Midlands (GB)

(72) Inventor: Greg HILL, Aberdeen (GB)

(21) Appl. No.: 15/377,370

(22) Filed: Dec. 13, 2016

(30) Foreign Application Priority Data
Dec. 24, 2015 (EP) 15202703.3

(51) Int. Cl. B65G 5/00

(52) U.S. Cl. CPC B65G 5/00

(57) ABSTRACT

A method for controlling the pressure in an underground storage volume, wherein the underground storage volume is at least in part filled with an incompressible fluid, the pressure is monitored, a compressible fluid can be introduced into and extracted from the underground storage volume, if the pressure reaches a predetermined upper pressure limit incompressible fluid is extracted from the underground storage volume for reducing the pressure in the underground storage volume; if the pressure volume reaches a predetermined lower pressure limit incompressible fluid is introduced into the underground storage volume for increasing the pressure in the underground storage volume. The method according to the present invention allows the increase the amount of compressible fluid like helium stored in an underground storage volume, e.g. a salt cavern, by adjusting the pressure by the introduction or extraction of an incompressible fluid like brine.

### CROSS REFERENCE TO RELATED APPLICATIONS

This application claims the benefit of priority under 35 U.S.C. §119 (a) and (b) to European Patent Application No. 15202703.3, filed Dec. 24, 2015, the entire contents of which are incorporated herein by reference.

### BACKGROUND

This document deals with storing a compressible fluid like helium in an underground storage volume, e.g. underground caverns and a method for controlling the pressure in such an underground storage volume if incompressible fluid is introduced or withdrawn from such an underground storage volume.

The use of underground caverns for storing gases and liquids like e.g. natural gas or crude oil and its products is known. Such underground caverns are e.g. leached in salt formations or created by hard rock mining. Such underground caverns need a minimum pressure to maintain the structural integrity of the cavern and to prevent collapsing of the cavern. In known approaches this is ensured by a minimum volume of gas which remains in the cavern at all times. This minimum volume of gas is usually denoted as pad gas. In known approaches a maximum amount of fluid to be stored in such a cavern exists.

### SUMMARY

It is an object of the present invention to provide a method for controlling the pressure in an underground storage volume in which the disadvantages known from prior art are at least in part overcome.

This object is solved by the features of the independent claims. The dependent claims deal with advantageous embodiments of the invention.

According to the present invention a method for controlling the pressure in an underground storage volume is proposed wherein the underground storage volume is at least in part filled with an incompressible fluid, wherein the pressure within the underground storage volume is monitored, wherein a compressible fluid can be introduced into and extracted from the underground storage volume, wherein if the pressure within the underground storage volume reaches a predetermined upper pressure limit incompressible fluid is extracted from the underground storage volume for reducing the pressure in the storage volume; wherein if the pressure within the underground storage volume reaches a predetermined lower pressure limit incompressible fluid is introduced into the underground storage volume for increasing the pressure in the underground storage volume.

The underground storage volume is preferably an underground cavern, in particular a leached cavern in a salt formation. Such caverns are generally characterized by a maximum pressure and a minimum pressure. If the pressure in the cavern is above the maximum presser or below the minimum pressure the cavern itself can be damaged. The values of the maximum and the minimum pressure depend mainly on the geological circumstances of the cavern, e.g. the kind of stones and/or the structure of the cavern. To clearly avoid a structural damage to the cavern the upper pressure limit is selected to be slightly below the maximum pressure, in particular to be about 1% below the maximum pressure and the lower pressure limit is selected to be slightly above the minimum pressure, in particular to be about 1% above the minimum pressure to ensure to use as much storage as possible.

As an incompressible fluid it is preferred to use brine as this is easily available in particular in leached caverns in salt formations. As a compressible fluid it is possible to use hydrogen or helium, in particular preferred helium.

The method according to the present invention allows a pressure management in which the incompressible fluid is used to adjust the pressure differences which are generated by introducing or withdrawing the compressible fluid. By this it is possible to avoid the use of pad gas. Further, by the multi cycle process in which the compressible gas is introduced into underground storage volume until the upper pressure limit is reached whereas then the pressure in the underground storage volume is reduced by removal of a part of the incompressible fluid so that the pressure within the cavern is reduced. This allows to introduce compressible fluid again increasing the amount of compressible fluid which can be stored in the underground storage volume. Preferably, incompressible fluid is withdrawn from the underground storage volume until the pressure in the underground storage volume has reached the lower pressure limit. Then, again, an amount of compressible fluid can be introduced into the underground storage volume, at most until the pressure in the underground storage volume has reached the upper pressure limit. By repeating this cycle the capacity of the underground storage volume to store the compressible fluid can be increased significantly.

Preferably, if it is not necessary to introduce compressible fluid into the underground storage volume the pressure in the underground storage volume is kept close to the upper pressure limit as this keeps a maximum of stored compressible fluid available. Usually, the compressible fluid is provided via a pipeline. Depending on the pressure in the underground storage it is, therefore, usually necessary to compress the compressible fluid to a higher pressure either when introducing the compressible fluid to the underground storage volume or when extracting the compressible fluid from the underground storage volume.

According to a preferred embodiment the introduction or extraction of the compressible fluid is terminated if while introducing compressible fluid the upper pressure limit is reached or if while extracting compressible fluid the lower pressure limit is reached.

This allows a safe use of the underground storage volume as it is possible to safely avoid to reach the maximum or minimum pressure which cannot be exceeded without structural damage to the underground storage volume.

In this context it is further preferred to terminate the introduction or extraction of the compressible fluid as long as at least one of the following conditions is fulfilled:

a) a predetermined delay since the beginning of the termination is elapsed; and

b) a predetermined pressure level has been reached.

This allows a certain reduction of the pressure in the underground storage volume if the introduction of compressible fluid has been terminated to let the pressure in the underground storage volume be reduced before it is again started to introduce compressible fluid into the underground storage volume. On the other hand this allows a certain increase of the pressure in the underground storage volume if the extraction of compressible fluid has been terminated to let the pressure in the underground storage volume be increased before it is again started to extract compressible fluid into the underground storage volume.

According to a further embodiment the incompressible fluid is delivered to a reservoir after extraction from the underground storage volume and is delivered from the reservoir to the underground storage volume for introduction into the underground storage volume.

The use of a reservoir allows a sustainable use of the underground storage volume. In particular, if brine is used as an incompressible fluid it is advantageous to provide a large brine reservoir close to the underground storage volume or the salt cavern allowing to use the brine instantly as the medium to increase the pressure in the underground storage volume.

According to a further improvement the compressible fluid is at least one of nitrogen, air, carbon dioxide, hydrogen, helium, and argon.

It is particularly preferred to use helium as the compressible fluid. With this invention it is easily possible to store helium with a high purity of e.g. more than 99 Vol.-% [Volume-%] in a salt cavern.

According to an improvement the compressible fluid is introduced to and extracted from the underground storage volume in the gaseous state The introduction and extraction of gaseous compressible fluid reduces the requirements to the equipment used. In particular, standard pumps can be used to compress the compressible fluid.

According to a further improvement the incompressible fluid is at least one of brine, water and water slurry.

Brine, water and water slurry are incompressible fluids that are easily available. In particular, brine is preferred, preferably if a salt cavern is used as an underground storage volume. Brine is understood to be a solution of at least one salt, in particular comprising sodium chloride (NaCl) in water (H₂O). The term water slurry is understood as a fluid mixture of a pulverized solid with water. It is in particular advantageous to use a water based incompressible fluid in the method according to the invention as some compressible fluids like e.g. are only soluble in water to a certain, limited degree. Therefore, if such a compressible fluid is stored in an underground storage volume which contains a significant amount of a water based incompressible fluid there is only a very limited loss of the compressible fluid and the compressible fluid and the incompressible fluid stay mainly separated.

According to a further improvement the compressible fluid is dehumidified after extraction from the underground storage volume.

Usually, the stored compressible fluid like e.g. helium is intended for further use after extraction from the underground storage volume it is necessary to provide it clean. The intake of humidity is possible to a certain degree and dehumidification allows to reduces the moisture or humidity significantly.

In this context it is preferred that the dehumidification is performed by guiding the compressible fluid through a molecular sieve.

As a molecular sieve preferably silica is used. Alternatively, an alumosilicate or a zeolite is a preferred variant of a molecular sieve.

According to a further improvement hydrocarbons are removed from the compressible fluid.

When using underground storage volumes for the storage of compressible fluids frequently deposits from the primary use of the underground storage volumes e.g. from mining remain. This can be either remains of the substance that has been mined or remains of chemicals used for mining. In this context it is preferred to remove hydrocarbons from the compressible fluid.

In this context it is preferred that the compressible fluid is guided through a bed of activated carbon for the removal of hydrocarbons.

The use of activated carbon is a reliable and economical advantageous way of removing hydrocarbons from the compressible fluid.

According to a further improvement atmospheric contaminants such as but not limited to oxygen, nitrogen and/or carbon dioxide are removed from the compressible fluid by pressure swing adsorption.

In particular, if hydrogen or helium are used as the compressible fluids atmospheric contaminants having a higher boiling point than the compressible fluid can contaminate the compressible fluid. Pressure swing adsorption is an easily applicable method for removing said contaminants from the compressible fluid.

According to a further embodiment the underground storage volume is an underground salt cavern.

Salt caverns have been found to provide storage volumes being tight even for the storage of gases with small molecules like hydrogen or helium as compressible fluids. Salt caverns are well accessible and usually directly provide a source for an incompressible fluid, namely brine.

According to a further improvement if compressible fluid has to be introduced into the underground storage volume the following steps are performed at least once:

a) reducing the pressure in the underground storage volume by extracting incompressible fluid, preferably until the lower pressure limit is reached; and

b) introducing the compressible fluid, preferably until the upper pressure limit is reached.

According to a further improvement if compressible fluid has to be extracted from the underground storage volume the following steps are performed at least once:

α) extracting compressible fluid from the underground storage volume, preferably until the lower pressure limit is reached; and

β) introducing the incompressible fluid to increase the pressure in the underground storage volume, preferably until the upper pressure limit is reached.

### BRIEF DESCRIPTION OF THE DRAWINGS

It should be noted that the individual features specified in the claims may be combined with one another in any desired technological reasonable manner and form further embodiments of the invention. The specification, in particular in connection with the figures, explains the invention further and specifies particularly preferred embodiments of the invention. Particularly preferred embodiments of the invention and also the technical field will now be explained in more detail on the basis of the enclosed figures. It should be noted that the exemplary embodiments shown in the figures are not intended to restrict the invention. The figures are schematic and may not be to scale. The figures display:

FIG. 1 a sample diagram of a pressure in an underground storage volume; and

FIG. 2 an example of an equipment to perform the method for controlling the pressure in an underground storage volume.

### DESCRIPTION OF PREFERRED EMBODIMENTS

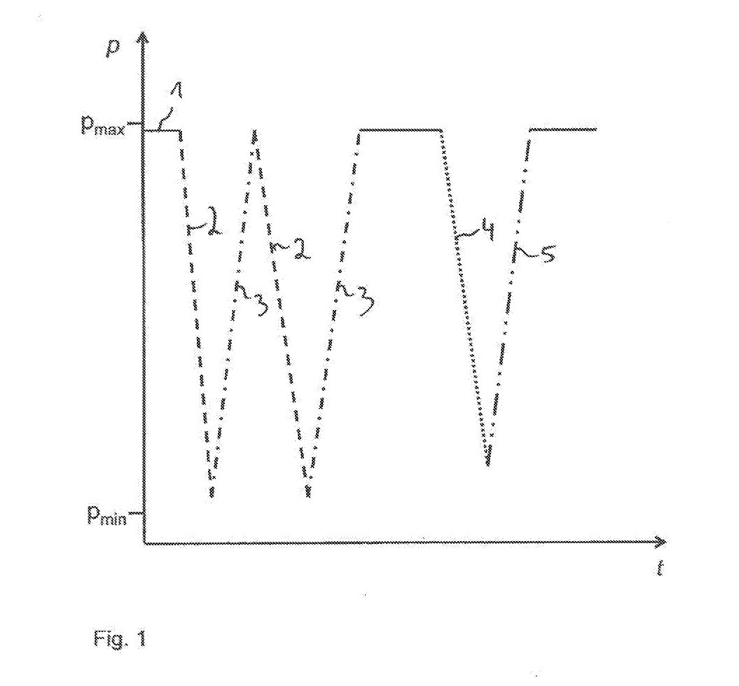

FIG. 1 displays the evolution of the pressure p in an underground storage volume against the time t. The underground storage volume is an underground salt cavern which has due to the geological properties a maximum pressure and a minimum pressure. It is filled both with an incompressible fluid, in this example brine, and a compressible fluid, in this example helium. It is used to store helium. Therefore, helium needs to be introduced and extracted from the underground storage volume frequently.

If the pressure p in the underground storage volume is above the maximum pressure or below the minimum pressure the structural integrity of the underground storage volume is endangered. Therefore, the pressure p in the underground storage volume is controlled to be within a predetermined pressure interval having a predetermined lower pressure limit pₘᵢₙ and a predetermined upper pressure limit pₘₐₓ which is well in between the maximum pressure and the minimum pressure. This ensures that the underground storage volume can be used without structural damage of the same.

Starting from a starting pressure 1 which is close to the upper pressure limit pₘₐₓ the need for storing more helium arises. If now in this situation helium would be introduced into the underground storage there would be the risk of structural damage to the underground storage volume. Therefore, first of all the pressure in the underground storage volume is reduced by extracting brine 2 from the underground storage volume until a pressure slightly above the lower pressure limit pₘᵢₙ. Then, helium is introduced in step 3 into the underground storage volume until a pressure close to the upper pressure limit pₘₐₓ has been reached. Then, in another step of extracting brine 2 the pressure is again reduced until a pressure close to the lower pressure limit pₘᵢₙ has been reached. In another step of introducing helium 3 into the underground storage volume another amount of helium is introduced into the underground storage volume. Now, for some time the pressure is kept constant in the underground storage volume until it is necessary to extract helium in a helium extraction step 4. Thereafter, to bring the pressure back to a pressure close to the upper pressure limit pₘₐₓ a step of introducing brine 5 to the underground storage volume is performed.

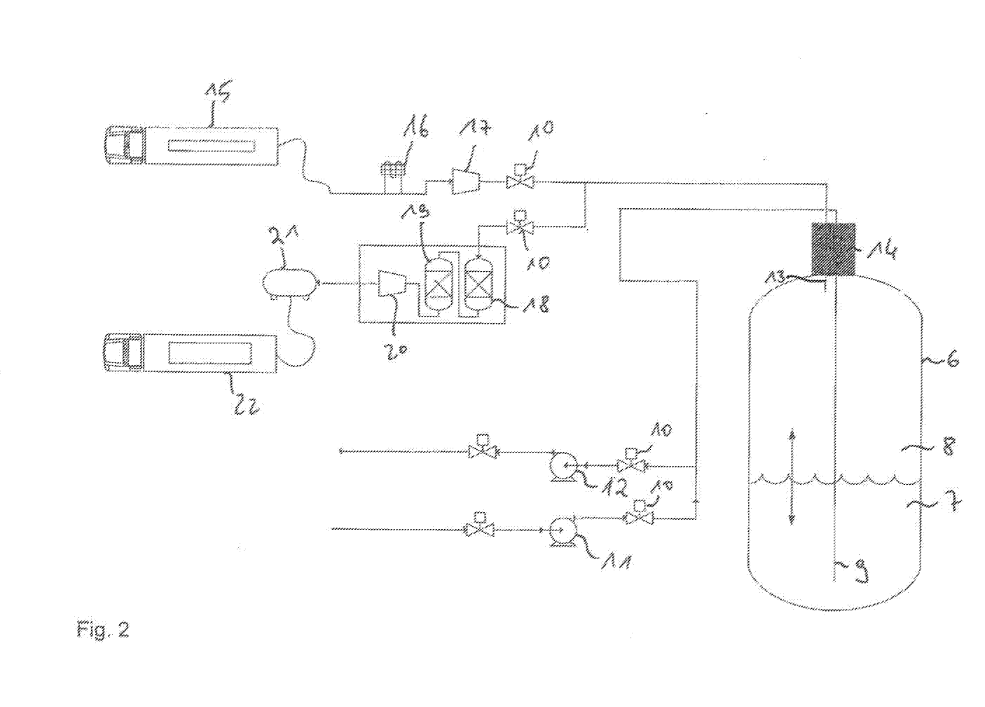

FIG. 2 displays schematically an equipment used to control the pressure in an underground storage volume 6 being a salt cavern. The underground storage volume 6 is filled partly with an incompressible fluid 7 namely brine and a compressible fluid 8 namely helium. The underground storage volume 6 is used to store the compressible fluid 8 which is to be extracted from the underground storage volume 6 in case of need and which has to be introduced into the underground storage volume 6 if it is needed to store the compressible fluid 8. If it is necessary to introduce incompressible fluid 7 into the underground storage volume 6 to increase the pressure within the underground storage volume 6 this is done in the base section of the underground storage volume 6 via a brine pipe 9 which is connected via valves 10 to a brine introduction pump 11. The brine introduction pump 11 convey brine as an incompressible fluid from a not shown reservoir through the brine pipe 9 into the bottom region of the underground storage volume 6. If incompressible fluid has to be extracted from the underground storage volume 6 this is done via the brine pipe 9 as well which is connected via a valve 10 to a brine extraction pump 12 to the reservoir. It is well noted that it is possible to combine the functions of the brine introduction pump 11 and the brine extraction pump 12 in one single pump.

Compressible fluid is introduced and extracted from the underground storage volume 6 via the helium pipe 13 which ends in the upper head section of the underground storage volume 6. Helium is lighter than brine, therefore, helium is collected in the head area of the underground storage volume 6 whereas brine is collected in the bottom area of the underground storage volume 6. The underground storage volume 6 is sealed via the seal 14 to avoid loss of helium.

In a first helium transporter 15 an amount of helium in the liquid state to be stored in the underground storage volume 6 is provided. This liquid helium is vaporized in a vaporizer 16 and is subsequently compressed in a compressor 17 to be provided via a valve 10 and the helium pipe to the head section of the underground storage volume 6. Instead of a first helium transporter 15 it is of course possible to convey the helium directly from a helium source to the underground storage volume 6.

In case of an extraction of helium from the underground storage volume 6 the helium is guided via the helium pipe 13 and a valve 10 to a unit 18 for dehumidifying the helium gas comprising a molecular sieve and, subsequently, to a unit 19 for the removal of hydrocarbons including a bed of activated carbon. Subsequently, the helium gas is provided to a liquefier 20 in which the helium gas is liquefied. The liquefied helium gas is provided to an intermediate helium storage 21 from which it can be filled to a second helium transporter 22. Instead of the second helium transporter 22 the helium can be directly provided to a point of use.

To control the pressure p within the underground storage volume 6 incompressible fluid—in this example brine—is introduced into the underground storage volume 6 to increase the pressure and is extracted from the underground storage volume 6 to decrease the pressure in the underground storage volume 6. By this the level of incompressible fluid is changing as is displayed by the arrow 23.

The method according to the present invention allows to increase the amount of compressible fluid like helium stored in an underground storage volume 6, e.g. a salt cavern, by adjusting the pressure by the introduction or extraction of an incompressible fluid like brine.

### REFERENCE NUMERALS

1 starting pressure
2 extracting brine
3 introducing helium
4 extracting helium
5 introducing brine
6 underground storage volume
7 incompressible fluid
8 compressible fluid
9 brine pipe
10 valve
11 brine introduction pump
12 brine extraction pump
13 helium pipe
14 seal
15 first helium transporter
16 evaporator
17 compressor
18 unit for dehumidifying
19 unit for the removal of hydrocarbons
20 liquefier
21 intermediate helium storage
22 second helium transporter
23 change of level of incompressible fluid
p pressure
pₘₐₓ upper pressure limit
pₘᵢₙ lower pressure limit
t time

What is claimed is:

1. A method for controlling the pressure in an underground storage volume,
wherein the underground storage volume is at least in part filled with an incompressible fluid,
wherein the pressure within the underground storage volume is monitored,
wherein a compressible fluid can be introduced into and extracted from the underground storage volume,
wherein if the pressure within the underground storage volume reaches a predetermined upper pressure limit (pₘₐₓ) incompressible fluid (7) is extracted from the underground storage volume for reducing the pressure (p) in the underground storage volume;
wherein if the pressure within the underground storage volume reaches a predetermined lower pressure (pₘᵢₙ) limit incompressible fluid is introduced into the underground storage volume for increasing the pressure in the underground storage volume.

2. The method of claim 1, wherein the introduction or extraction of the compressible fluid is terminated if while introducing compressible fluid the upper pressure limit (pₘₐₓ) is reached or if while extracting compressible fluid the lower pressure limit (pₘᵢₙ) is reached.

3. The method of claim 2, wherein the introduction or extraction of the compressible fluid is terminated as long as at least one of the following conditions is fulfilled:
a) a predetermined delay since the beginning of the termination is elapsed; and
b) a predetermined pressure level has been reached.

4. The method of claim 1, wherein the incompressible fluid is delivered to a reservoir after extraction from the underground storage volume and is delivered from the reservoir to the underground storage volume for introduction into the underground storage volume.

5. The method of claim 1, wherein the compressible fluid is at least one of nitrogen, air, carbon dioxide, hydrogen, helium, and argon.

6. The method of claim 5, wherein the compressible fluid is introduced to and extracted from the underground storage volume in the gaseous state.

7. The method of claim 1, wherein the incompressible fluid is at least one of brine, water and water slurry.

8. The method claim 1, wherein the compressible fluid is dehumidified after extraction from the underground storage volume.

9. The method of claim 8, wherein the dehumidification is performed by guiding the compressible fluid through a molecular sieve.

10. The method of claim 1, wherein hydrocarbons are removed from the compressible fluid.

11. The method of claim 10, wherein the compressible fluid is guided through a bed of activated carbon for the removal of hydrocarbons.

12. The method of claim 1, wherein atmospheric contaminants such as oxygen, nitrogen, carbon hydroxide are removed from the compressible fluid by pressure swing adsorption.

13. The method of claim 1, wherein the underground storage volume is an underground salt cavern.

14. The method of claim 1, wherein if compressible fluid has to be introduced into the underground storage volume the following steps are performed at least once:
a) reducing the pressure in the underground storage volume by extracting incompressible fluid, and
b) introducing the compressible fluid.

15. The method of claim 1, wherein if compressible fluid has to be extracted from the underground storage volume the following steps are performed at least once:
α) extracting compressible fluid from the underground storage volume; and
β) introducing the incompressible fluid to increase the pressure in the underground storage volume.
